(19) United States
(12) Patent Application Publication
(10) Pub. No.: US 2026/0010998 A1
(43) Pub. Date: Jan. 8, 2026

(54) Board Inspection System and Board Inspection Method

(71) Applicant: SHIMADZU CORPORATION, Kyoto-shi (JP)

(72) Inventor: Kazuki KANAMOTO, Kyoto-shi (JP)

(21) Appl. No.: 19/248,245

(22) Filed: Jun. 24, 2025

(30) Foreign Application Priority Data
Jun. 26, 2024 (JP) 2024-103180

(51) Int. Cl. G06T 7/00; G06T 7/62; G06T 7/66

(52) U.S. Cl. CPC G06T 7/0004; G06T 7/62; G06T 7/66; G06T 2207/10116

(57) ABSTRACT

A board inspection system according to this invention includes an X-ray imaging apparatus performing X-ray imaging of a board on which a solder ball is placed; and a board inspection apparatus including an inspection apparatus controller generating an X-ray image of the board, wherein the inspection apparatus controller generates a determination image based on the X-ray image of the board, and determines whether a shape of the solder ball is proper or improper based on a plurality of distances from a center of gravity G of a solder ball area to a plurality of outer edge parts of the solder ball area in the determination image.

### CROSS-REFERENCE TO RELATED APPLICATIONS

The related application number JP2024-103180, board inspection system and board inspection method, Jun. 26, 2024, Kazuki Kanamoto, upon which this patent application is based is hereby incorporated by reference.

### BACKGROUND OF THE INVENTION

### Field of the Invention

The present invention relates to a board inspection system and a board inspection method, in particular, to a board inspection system and a board inspection method for generating an X-ray image of a board on which a solder ball is placed.

### Description of the Background Art

X-ray imaging systems for generating X-ray images of boards on which solder balls are placed are known in the art. Such an apparatus is disclosed in Japanese Patent Laid-Open Publication No. JP 2024-29975, for example.

The above Japanese Patent Laid-Open Publication No. JP2024-29975 discloses an X-ray imaging system including a fluoroscopic device generating X-ray images of a board on which solder balls are placed and an analysis device analyzing the X-ray image generated. In the above X-ray imaging system described in Japanese Patent Application Publication No. 2024-29975, inspection for a defect of shapes and the like in the solder balls is performed based on the X-ray image generated.

Here, although not stated in the above Patent Document 1, in a case in which the shapes of solder balls are inspected in known X-ray imaging systems such as the X-ray imaging system disclosed in the above Patent Document 1, determination images representing board and solder ball areas are generated by binarizing X-ray images of the board on which the solder balls are placed. In this case, roundness of each solder ball area captured in the determination image is calculated based on its area, perimeter and the like. Then, based on respective values of the roundness of the plurality of solder ball areas, it is determined whether the shapes of the plurality of solder balls are a proper shape or an improper shape.

However, in the aforementioned determination using roundness, even if the solder ball has an improper shape including a local convex/concave shape, in a case in which the solder ball has both convex and concave parts, for example, its area and perimeter may be close to those of a perfect circular solder ball. In this case, the difference between the calculated roundness of the solder ball that has the improper shape and the roundness of the solder ball that has the proper shape may be very small, or there may be no noticeable difference at all. For this reason, the shapes of solder balls may not be accurately determined based on their roundness in some cases. From this viewpoint, a board inspection system and a board inspection method capable of accurately determining whether the shapes of solder balls are proper or improper are desired.

### SUMMARY OF THE INVENTION

The present invention is intended to solve the above problem, and one object of the present invention is to provide a board inspection system and a board inspection method capable of accurately determining whether a shape of a solder ball is proper or improper.

### MEANS FOR SOLVING THE PROBLEMS

In order to attain the aforementioned object, a board inspection system according to a first aspect of the present invention includes an X-ray imaging apparatus performing X-ray imaging of a board on which a solder ball is placed; and an inspection apparatus including a controller generating an X-ray image of the board captured by the X-ray imaging through the X-ray imaging apparatus, wherein the controller generates a determination image based on the X-ray image of the board captured by the X-ray imaging through the X-ray imaging apparatus, and determines whether a shape of the solder ball is proper or improper based on a plurality of distances from a center of gravity of a solder ball area to a plurality of outer edge parts of the solder ball area in the determination image.

Also, in order to attain the aforementioned object, a board inspection method according to a second aspect of the present invention includes an imaging step of performing X-ray imaging of a board on which a solder ball is placed; an X-ray image generation step of generating an X-ray image of the board captured by the X-ray imaging; a determination-image generation step of generating a determination image based on the X-ray image; and a determination step of determining whether a shape of the solder ball is proper or improper based on a plurality of distances from a center of gravity of a solder ball area to a plurality of outer edge parts of the solder ball area in the determination image.

In the board inspection system according to the first aspect and the board inspection method according to the second aspect, as discussed above, the controller performs the determination step of determining whether a shape of the solder ball is proper or improper based on a plurality of distances from a center of gravity of the solder ball area to a plurality of outer edge parts of the solder ball area in the determination image. Accordingly, even in a case in which a solder ball has a local convex/concave shape or the like, which cannot be evaluated by its roundness, it is possible to determine whether a shape of the solder ball is proper or improper by using a difference between distances from a local convex/concave shape part having the local convex/concave shape or the like and a round part to the center of gravity. Consequently, it is possible to provide a board inspection system and a board inspection method capable of accurately determining whether the shape of the solder ball is proper or improper.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an overall configuration of a board inspection system according to one embodiment of the present invention.

FIG. 2 is a view showing a board on which solder balls are placed according to the one embodiment of the present invention.

FIG. 3 is a view illustrating an X-ray image generated in the board inspection system according to the one embodiment of the present invention.

FIG. 4 is a view illustrating a determination image generated in the board inspection system according to the one embodiment of the present invention.

FIG. 5 is a view illustrating a solder ball area having a proper shape according to the one embodiment of the present invention.

FIG. 6 is a view illustrating a solder ball area including a convex part according to the one embodiment of the present invention.

FIG. 7 is a view illustrating a solder ball area including a concave part according to the one embodiment of the present invention.

FIG. 8 is a view illustrating a determination result using the determination image according to the one embodiment of the present invention.

FIG. 9 is a flowchart illustrating operations performed by a controller according to the one embodiment of the present invention.

FIG. 10 is a view illustrating a solder ball area including both convex and concave parts according to a modified example of the one embodiment of the present invention.

### DESCRIPTION OF THE PREFERRED EMBODIMENT

The following description will describe an embodiment embodying the present invention with reference to the drawings.

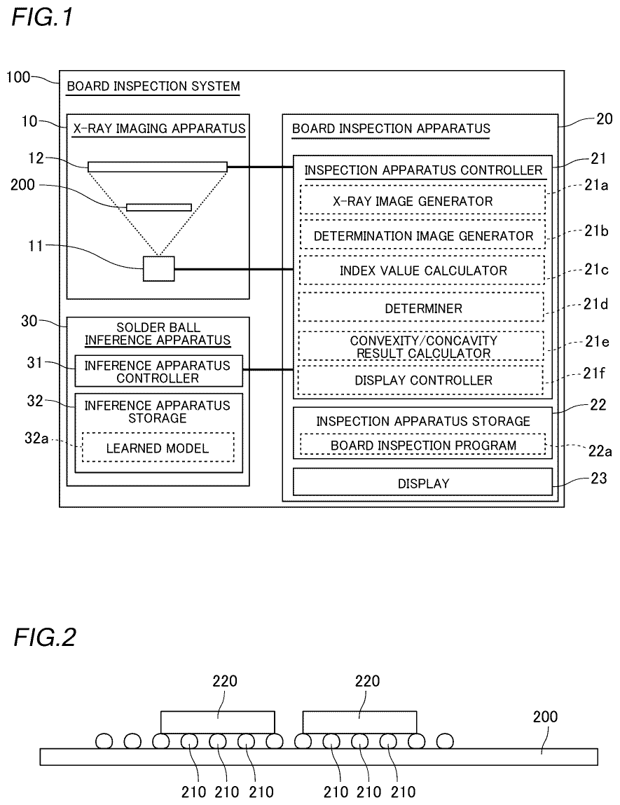

The following description describes a board inspection system 100 according to this embodiment with reference to FIGS. 1 to 8.

### Overall Configuration of Board Inspection System

As shown in FIG. 1, the board inspection system 100 includes an X-ray imaging apparatus 10, a board inspection apparatus 20, and a solder ball inference apparatus 30. The board inspection system 100 is a system for inspecting shapes of a plurality of solder balls 210 (bumps) (see FIG. 2) placed on a board 200. The X-ray imaging apparatus 10 and the solder ball inference apparatus 30 are connected to the board inspection apparatus 20, which will be described later, to be able to communicate with each other.

As shown in FIG. 2, the plurality of solder balls 210 and electronic components 220 are arranged on the board 200. The electronic components 220 are electrically connected to the board 200 through the plurality of solder balls 210. The plurality of solder balls 210 have approximately the same size as each other. The plurality of solder balls 210 are arranged in a grid pattern on the board 200. In other words, the electronic components 220 are connected to the board 200 through a BGA (Ball Grid Array). The electronic components 220 are chip capacitors, for example.

### Configuration of X-Ray Imaging Apparatus

As shown in FIG. 1, the X-ray imaging apparatus 10 is an apparatus for performing X-ray imaging of the board 200 on which the plurality of solder balls 210 (see FIG. 2) are placed. The X-ray imaging apparatus 10 includes an X-ray irradiator 11 and an X-ray detector 12.

The X-ray irradiator 11 is configured to irradiate the board with X-rays. The X-ray irradiator 11 includes an X-ray tube configured to irradiate the board with X-rays when electric power is supplied from a power supply (not shown). The X-ray irradiator 11 irradiates the board 200 on which the plurality of solder balls 210 (see FIG. 2) are placed with X-rays.

The X-ray detector 12 detects X-rays with which the board is irradiated by the X-ray irradiator 11. The X-ray detector 12 outputs electrical signals corresponding to X-rays detected. The X-ray detector 12 is a flat panel detector (FPD), for example. The electrical signals output from the X-ray detector 12 are input to the inspection apparatus controller 21, which will be described later, of the board inspection apparatus 20.

### Configuration of Board Inspection Apparatus

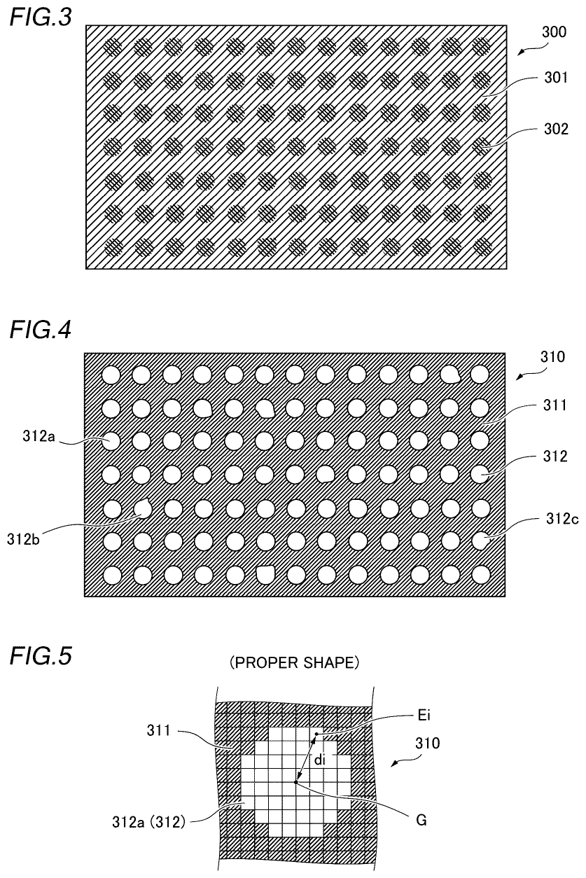

As shown in FIG. 1, the board inspection apparatus 20 is an apparatus for inspecting shapes and the like of the solder balls 210 (see FIG. 2) placed on the board 200 by using an X-ray image 300 (see FIG. 3), which is captured by X-ray imaging by using the X-ray imaging apparatus 10, of the board 200 on which the plurality of solder balls 210 are placed. The board inspection apparatus 20 includes an inspection apparatus controller 21, an inspection apparatus storage 22 and a display 23.

The inspection apparatus controller 21 controls X-ray irradiation by the X-ray irradiator 11 by controlling the power supply (not shown). The inspection apparatus controller 21 includes a processor, such as a CPU (Central Processing Unit), a GPU (Graphics Processing Unit) and an FPGA (Field-Programmable Gate Array) configured for image processing, and a memory, such as a ROM (Read Only Memory) and a RAM (Random Access Memory), for example. Here, the inspection apparatus controller 21 is an example of a “controller” in the claims.

The inspection apparatus storage 22 stores various programs to be executed by the inspection apparatus controller 21, various parameters, and the like. The inspection apparatus storage 22 includes a nonvolatile memory, such as an HDD (Hard Disk Drive) or an SSD (Solid State Drive), for example. The inspection apparatus storage 22 stores a board inspection program 22a, which will be described later.

The display 23 is a liquid crystal display, for example. The display 23 is controlled by the inspection apparatus controller 21 to display images including text information and the like. The display 23 indicates the determination results and the like using a determination image 310 selected (see FIG. 4).

### Configuration of Solder Ball Inference Apparatus

As shown in FIG. 1, the solder ball inference apparatus 30 is an apparatus for inferring a part in the X-ray image 300 that is a solder ball area 312 (see FIG. 3). The solder ball inference apparatus 30 includes an inference apparatus controller 31 and an inference apparatus storage 32.

The inference apparatus controller 31 includes a processor, such as a CPU, GPU and FPGA, configured for image processing, and a memory such as ROM and RAM, for example. The inference apparatus controller 31 generates a probability image (inference image) representing a probability of the part in the X-ray image 300 (see FIG. 3), which is input from the inspection apparatus controller 21 of the board inspection apparatus 20, that is the solder ball area 312 (see FIG. 3) by using a learned model 32a, which will be described later, stored in the inference apparatus storage 32.

The inference apparatus storage 32 stores various programs to be executed by the inference apparatus controller 31, various parameters, and the like. The inference apparatus storage 32 includes a nonvolatile memory such as an HDD and an SSD, for example. The inference apparatus storage 32 stores the learned model 32a, which previously learned parts in X-ray images 300 (see FIG. 3) that are solder ball areas 312 (see FIG. 3) based on machine learning using a large number of data sets of X-ray images 300.

### Configuration of Controller of Board Inspection Apparatus

As shown in FIG. 1, the inspection apparatus controller 21 includes an X-ray image generator 21a, a determination image generator 21b, an index value calculator 21c, a determiner 21d, a convexity/concavity result calculator 21e and a display controller 21f as functional blocks. The X-ray image generator 21a, the determination image generator 21b, the index value calculator 21c, the determiner 21d, the convexity/concavity result calculator 21e and the display controller 21f are constructed of the functional blocks as software realized by executing the board inspection program 22a stored in the inspection apparatus storage 22 by the inspection apparatus controller 21. In other words, the board inspection program 22a causes a computer (inspection apparatus controller 21) to execute control to be performed by the X-ray image generator 21a, the determination image generator 21b, the index value calculator 21c, the determiner 21d, the convexity/concavity result calculator 21e and the display controller 21f.

### X-Ray Image Generator

The X-ray image generator 21a (see FIG. 1) generates the X-ray image 300 of the board 200 (see FIG. 1) shown in FIG. 3, which is captured by X-ray imaging. Specifically, as shown in FIG. 1, the X-ray image generator 21a generates the X-ray image 300 based on electrical signals output from the X-ray detector 12 of the X-ray imaging apparatus 10. The X-ray image 300 includes a board part 301 in which the board 200 (see FIG. 1) is captured and solder ball part 302 in which the solder balls 210 (see FIG. 1) are captured.

### Determination Image Generator

As shown in FIG. 4, the determination image generator 21b (see FIG. 1) generates the determination image 310 in which the solder ball areas 312 are extracted from the X-ray image 300. Specifically, as shown in FIG. 1, the determination image generator 21b inputs the X-ray image 300 (see FIG. 3) to the inference apparatus controller 31 of the solder ball inference apparatus 30. The inference apparatus controller 31 of the solder ball inference apparatus 30 generates the inference image (not shown) representing the probability of the part in the X-ray image 300, which is input from the inspection apparatus controller 21 of the board inspection apparatus 20, that is the solder ball 210 (see FIG. 1) by using a learned model 32a stored in the inference apparatus storage 32 of the solder ball inference apparatus 30. The inference apparatus controller 31 of the solder ball inference apparatus 30 outputs the inferred image generated to the inspection apparatus controller 21 of the board inspection apparatus 20. The determination image generator 21b binarizes the inference image output from the inference apparatus controller 31 of the solder ball inference apparatus 30 to generate the determination image 310 shown in FIG. 4.

Here, as shown in FIG. 4, the determination image 310 includes a board area 311 representing a part in which the board 200 (see FIG. 1) exists, and the solder ball areas 312 representing parts in which solder balls 210 (see FIG. 1) exist. In this case, the plurality of solder ball areas 312 included in the determination image 310 may include both solder ball areas having a proper shape such as nearly perfect circular shapes, and solder ball areas having improper shapes including local convex/concave shapes. For example, the solder ball area 312a has a nearly perfect circular shape, the solder ball area 312b has an improper shape including a convex part, and the solder ball area 312c has an improper shape including a concave part.

### Indicator Value Calculator

The index value calculator 21c calculates index values V for determining whether the plurality of solder balls 210 on the board 200 have a proper shape or an improper shape all at once in the captured area based on the X-ray image 300 and the determination image 310. Here, calculation of the index value V performed by the index value calculator 21c is now described in detail with reference to FIG. 5 showing an enlarged solder ball area 312a having a proper shape as one of the solder ball areas 312 in the determination image 310. Also, in FIG. 5, the ratio of the pixel size to the solder ball area 312 is shown larger than its actual ratio for illustrative purposes.

The index value calculator 21c acquires an average radius Rₐᵥₑ of the solder ball area 312a. The average radius Rₐᵥₑ is a radius that is hypothetically calculated by assuming that the solder ball area 312 is circular, even if it is not actually circular. The index value calculator 21c calculates an area S of the solder ball area 312a based on the number of pixels that form the solder ball area 312a and an area of each pixel (picture element), which is previously obtained as an area per unit. The index value calculator 21c acquires the average radius Rₐᵥₑ of the solder ball area 312a by dividing the calculated area S by the ratio of the circumference of a circle to its diameter I and then finding the square root of it. In other words, the average radius Rₐᵥₑ calculated by the index value calculator 21c is represented by the following formula.

$${R}_{a v e} = \sqrt{\frac{S}{π}} \qquad [ Formula 1 ]$$

Also, the index value calculator 21c acquires a center of gravity G of the solder ball area 312a. For example, the index value calculator 21c obtains coordinates of the pixels that form the solder ball area 312a where a point on the upper left of the determination image 310 (see FIG. 4) is defined as a reference point as coordinates (0, 0). In this acquisition, the index value calculator 21c calculates an average value of x coordinates and an average value of y coordinates of the that form the solder ball area 312a, and sets the coordinates calculated as the center of gravity G. In the description of this embodiment, coordinates of the center of gravity G are represented as (x_{g}, y_{g}).

Also, the index value calculator 21c calculates a plurality of distances di from the center of gravity G to a plurality of outer edge parts Ei of the solder ball area 312a. The outer edge parts Ei of the solder ball area 312a are defined as coordinates of the pixels of parts of the solder ball area 312a that are positioned adjacent to the board area 311, which is distinguished through the binarization, and include a plurality of coordinate sets such as E₁, E₂. . . . Eₙ (n=20 in a case of FIG. 5). In the description of this embodiment, the coordinates of the outer edge parts Ei are represented as (xᵢ, yᵢ). Each of the distances di the number of which corresponds to the number of the coordinate sets of the outer edge parts Ei is calculated based on the following formula.

$${d}_{i} = \sqrt{{( {x}_{i} - {x}_{g} )}^{2} + {( {y}_{i} - {y}_{g} )}^{2}} \qquad [ Formula 2 ]$$

Also, the index value calculator 21c calculates one index value V based on the average radius Rₐᵥₑ and the distances di from the center of gravity G to the plurality of outer edge parts Ei of the solder ball area 312a. The index value V is a value used for determination whether the solder ball area 312 is proper or improper, which will be described later, and is calculated based on the following mean squared error formula. In this embodiment, the calculated index value V of the solder ball area 312a is 0.18.

$$V = {\sum }_{i = 1}^{n} \frac{{( {R}_{a v e} - {d}_{i} )}^{2}}{n} ] \qquad [ Formula 3 ]$$

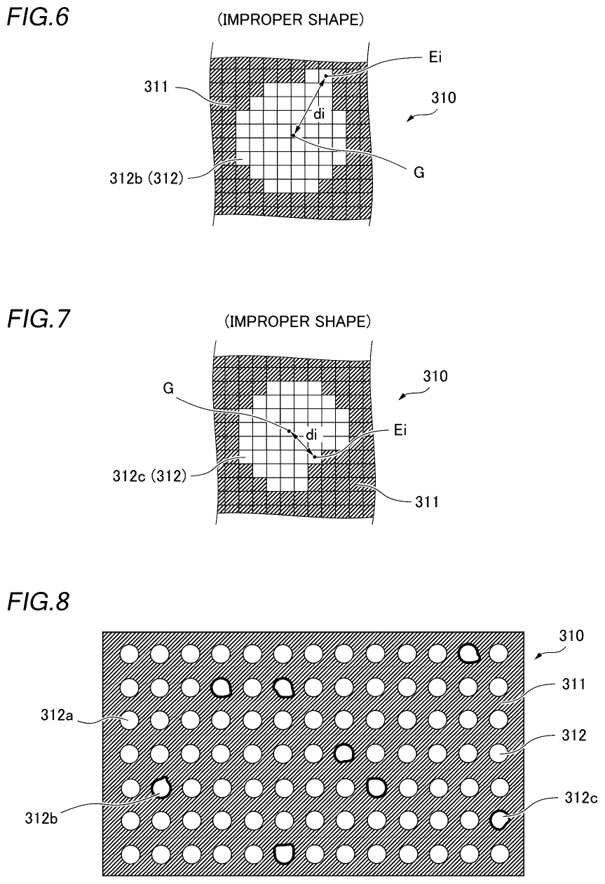

Here, the index value calculator 21c calculates index values V all at once in areas captured so that index values V are similarly calculated for the solder ball area 312b shown in FIGS. 4 and 6, and the solder ball area 312c shown in FIGS. 4 and 7, for example. Also, in FIGS. 6 and 7, the ratio of the pixel size to the solder ball area 312 is shown larger than its actual ratio for illustrative purposes.

Here, as shown in FIG. 6, the solder ball area 312b including the convex part has the same distance di as the solder ball area 312a (see FIG. 5) in many parts, however the distance di is larger in the convex part. Also, since the number of pixels that the solder ball area 312b including the convex part is greater as compared with the number of pixels that form the solder ball area 312a having the proper shape, its average radius Rₐᵥₑ becomes larger. In other words, absolute values of (Rₐᵥₑ−dᵢ) in the parts used to calculate the index value V become slightly larger overall, and the absolute values in the convex part become significantly large. Accordingly, the calculated index value V of the solder ball area 312b becomes larger than the index value V of the solder ball area 312a. In this embodiment, the calculated index value V of the solder ball area 312b is 4.65.

Also, as shown in FIG. 7, the solder ball area 312c including the concave part has the same distance di as the solder ball area 312a (see FIG. 5) in many parts, however the distance di is smaller in the concave part. Also, since the number of pixels that the solder ball area 312c including the concave part is smaller as compared with the number of pixels that form the solder ball area 312a having the proper shape, its average radius Rₐᵥₑ becomes small. In other words, absolute values of (Rₐᵥₑ−dᵢ) in the parts used to calculate the index value V become slightly larger overall, and the absolute values in the concave part become significantly large. Accordingly, the calculated index value V of the solder ball area 312c becomes larger than the index value V of the solder ball area 312a. In this embodiment, the calculated index value V of the solder ball area 312c is 5.17.

### Determiner

The determiner 21d (see FIG. 1) determines whether each solder ball area 312 in the determination image 310 has a proper shape or an improper shape based on the index value V calculated by the index value calculator 21c and a threshold previously set by an operator or similar personnel. For example, in a case in which the threshold is previously set as “3.0” by an operator or similar personnel, the determiner 21d determines that the solder ball area 312 has a proper shape if its calculated index value V is not greater than 3.0, and determines that the solder ball area 312 has an improper shape if its calculated index value V is greater than 3.0 in the determination image 310. Accordingly, the solder ball area 312a, which has an almost perfect circular shape and an index value V of 0.18 is determined to have a proper shape, while the solder ball area 312b and the solder ball area 312c, which include the convex part and the concave part and have an index value V of 4.65 and an index value V of 5.17, respectively, are determined to have improper shapes. Here, the determination is applied to a single determination image 310 in one operation.

### Convexity/Concavity Result Calculator

The convexity/concavity result calculator 21e (see FIG. 1) calculates a result of whether the solder ball area 312 that is determined to have an improper shape by the determiner 21d has a convex part or a concave part. Specifically, the convexity/concavity result calculator 21e calculates, in parts that are used to calculate index values V by the index value calculator 21c, the number of parts that satisfy a condition in which (Rₐᵥₑ−dᵢ) is a positive value and the number of parts that satisfy a condition in which (Rₐᵥₑ−dᵢ) is a negative value. Subsequently, the convexity/concavity result calculator 21e calculates a result indicating that the solder ball area 312 includes a convex part if the number of outer edge parts that satisfy a positive-value condition in which their (Rₐᵥₑ−dᵢ) is a positive value is greater than the number of outer edge parts that satisfy a negative-value condition in which their (Rₐᵥₑ−dᵢ) is a negative value, and a result indicating that the solder ball area 312 includes a concave part if the number of outer edge parts that satisfy the negative-value condition is greater than the number of outer edge parts that satisfy the positive-value condition.

For example, in the solder ball area 312b shown in FIG. 6, the number of outer edge parts that satisfy the positive-value condition in which their (Rₐᵥₑ−dᵢ) is a positive value is 19, and the number of outer edge parts that satisfy the negative-value condition is 3 so that the convexity/concavity result calculator calculates the result indicating that the solder ball area 312b includes a convex part. Also, in the solder ball area 312c shown in FIG. 7, the number of outer edge parts that satisfy the positive-value condition in which their (Rₐᵥₑ−dᵢ) is a positive value is 3, and the number of outer edge parts that satisfy the negative-value condition is 17 so that the convexity/concavity result calculator calculates the result indicating that the solder ball area 312c includes a concave part.

### Display Controller

The display controller 21f (see FIG. 1) displays a result that is determined by the determiner 21d and a result that is calculated by the convexity/concavity result calculator 21e on the display 23. As shown in FIG. 8, for example, the display controller 21f highlights the solder ball areas 312 that are determined by the determiner 21d to have an improper shape by surrounding them with thick lines around their peripheries, for example. Alternatively, the display controller 21f may cause the solder ball areas 312b, which include the convex part, and the solder ball areas 312c, which include the concave part, to be identifiably displayed in different colors on the display 23.

### BOARD INSPECTION METHOD

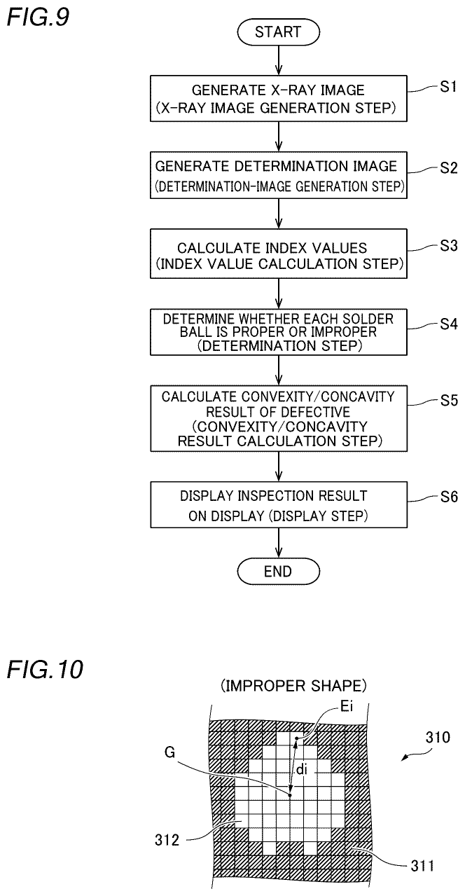

The following description describes a board inspection method according to this embodiment with reference to a flowchart of FIG. 9.

As shown in FIG. 9, as a process of an X-ray image generation step, step S1 of generating the X-ray image 300 is first performed. In step S1, the X-ray image 300 (see FIG. 3), which is captured by X-ray imaging using the X-ray imaging apparatus 10 (see FIG. 1), of the board 200 on which the solder balls 210 (see FIG. 2) are placed is generated. Here, step S1 is performed by the X-ray image generator 21a of the inspection apparatus controller 21 of the board inspection apparatus 20 (see FIG. 1).

Subsequently, as shown in FIG. 9, as a process of a determination-image generation step, step S2 of generating the determination image 310 is performed. In step S2, as shown in FIG. 3, the determination image 310 of the board 200 on which the solder balls 210 (see FIG. 2) are placed is generated by extracting the solder ball areas 312 from the X-ray image 300. Here, step S2 is performed by the determination image generator 21b of the inspection apparatus controller 21 of the board inspection apparatus 20 (see FIG. 1).

Subsequently, as shown in FIG. 9, as a process of an index value calculation step, step S3 of calculating the index values V is performed. In step S3, the index values V are calculated for the plurality of solder ball areas 312 based on their average radii Rₐᵥₑ of the plurality of solder ball areas 312 and their distances di from the center of gravity G to their outer edge parts Ei based on the determination image 310. Here, step S3 is performed by the index value calculator 21c of the inspection apparatus controller 21 of the board inspection apparatus 20 (see FIG. 1).

Subsequently, as shown in FIG. 9, as a process of a determination step, step S4 of determining whether each solder ball area 312 has a proper shape or an improper shape. In step S4, based on the index value V for each of the plurality of solder ball areas 312, it is determined whether the index value V for each of the plurality of solder ball areas 312 is not greater than the threshold so that the solder ball area 312 that has an index value V greater than the threshold is determined to have an improper shape. In other words, the solder ball 210 (see FIG. 2) that corresponds to the solder ball area 312 determined to have an improper shape in the determination image 310 is determined to have an improper shape. In this determination, the board 200 on which the shaped solder ball 210 that has an improper shape is placed may be determined to be a defective. Here, step S4 is performed by the determiner 21d of the inspection apparatus controller 21 of the board inspection apparatus 20 (see FIG. 1).

Subsequently, as shown in FIG. 9, as a process of a convexity/concavity result calculation step, step S5 of calculating a convexity/concavity result is performed. In step S5, the respective numbers of parts that satisfy positive-value and negative conditions in which their (Rₐᵥₑ−dᵢ) is a positive value and in which it is a negative value are calculated in parts used to calculate the index value V for the solder ball area 312 that is determined to have an improper shape in the determination image 310 in step S4. Then, the convexity/concavity result regarding whether the solder ball area 312 includes a convex part or a concave part is calculated in accordance with the respective numbers of parts that satisfy the positive-value and negative conditions. Here, step S5 is performed by the convexity/concavity result calculator 21e of the inspection apparatus controller 21 of the board inspection apparatus 20 (see FIG. 1).

Subsequently, as shown in FIG. 9, as a process of a display step, step S6 of displaying an inspection result on the display 23 is performed. In step S6, results determined or calculated in step S4 and step S5 are identifiably displayed on the display 23. Here, step S5 is performed by the display controller 21f of the inspection apparatus controller 21 of the board inspection apparatus 20 (see FIG. 1). The inspection of the board 200 is completed by the aforementioned processes.

### ADVANTAGES OF THE EMBODIMENT

In this embodiment, the following advantages are obtained.

### Advantages of Board Inspection System

In the board inspection system 100 according to this embodiment, as described above, the inspection apparatus controller 21 generates the determination image 310 based on the X-ray image 300 of the board 200 captured by X-ray imaging through the X-ray imaging apparatus 10, and determines whether a shape of each solder ball 210 is proper or improper based on a plurality of distances di from a center of gravity G of each solder ball area 312 to a plurality of outer edge parts Ei of the solder ball area in the determination image 310. Accordingly, even in a case in which the solder ball 210 has a local convex/concave shape or the like, which cannot be evaluated by its roundness, it is possible to determine whether a shape of the solder ball 210 is proper or improper by using a difference between distances di from a local convex/concave part having the local convex/concave shape or the like and a round part to the center of gravity G. Consequently, it is possible to accurately determine whether the shape of the solder ball 210 is proper or improper.

In addition, additional advantages can be obtained by the board inspection system 100 according to this embodiment added with configurations discussed below.

That is, in the board inspection system 100 according to this embodiment, as described above, the inspection apparatus controller 21 calculates an index value V for determining whether the shape of the solder ball 210 is proper or improper based on distances di from the center of gravity G to the outer edge parts Ei of the solder ball area 312 in the determination image 310. Accordingly, dissimilar to a case in which it is determined whether each solder ball 210 is proper or improper by checking all the plurality of distances di from the center of gravity G to the plurality of outer edge parts Ei of the solder ball area 312 in the determination image 310, since it can be determined whether each solder ball 210 is proper or improper only based on the calculated index value V, it is possible to easily determine whether the solder ball 210 is proper or improper.

Also, in the board inspection system 100 according to this embodiment, as described above, the inspection apparatus controller 21 calculates the index value V based on differences between an average radius Rₐᵥₑ calculated based on an area S of the solder ball area 312 in the determination image 310 and the plurality of distances di from the center of gravity G to the plurality of outer edge parts Ei of the solder ball area 312. Accordingly, it is possible to know how much radii directly derived as the plurality of distances di from the center of gravity G to the plurality of outer edge parts Ei deviate from the average radius Rₐᵥₑ of the solder ball 210 (how much error is included). Consequently, in a case in which the solder ball 210 includes a local convex/concave having the local convex/concave shape and the like, the index value V can reflect the degree to which the part is convex or concave. Consequently, it is possible to more accurately determine whether the shape of the solder ball 210 is proper or improper.

Also, in the board inspection system 100 according to this embodiment, as described above, the inspection apparatus controller 21 calculates a mean squared error between the average radius Rₐᵥₑ calculated based on the area S of the solder ball area 312 in the determination image 310 and the plurality of distances di from the center of gravity G to the plurality of outer edge parts Ei of the solder ball area 312 as the index value V. Accordingly, since errors between the average radius Rₐᵥₑ of the solder ball 210 and the plurality of distances di from the center of gravity G to the plurality of outer edge parts Ei are squared, an index value V is calculated to emphasize the error amount. Consequently, it can be more accurately determined whether the shape of the solder ball 210 is proper or improper by using the index value V emphasizing the error amount.

Also, in the board inspection system 100 according to this embodiment, as described above, the inspection apparatus controller 21 calculates the area S of each solder ball area 312 based on the number of pixels that are included in the solder ball area 312 in the determination image 310 and an area of each pixel, calculates the average radius Rₐᵥₑ of the solder ball area 312 based on the area S calculated of the solder ball area 312 and pi, and calculates the index value V based on the differences between the calculated average radius Rₐᵥₑ of the solder ball area 312 and the plurality of distances di from the center of gravity G to the plurality of outer edge parts Ei of the solder ball area 312. Accordingly, since the average radius Rₐᵥₑ is calculated based on the area S of each solder ball area 312 and the number of pixels that are included in the solder ball area 312 in the determination image 310, even in a case in which the solder ball 210 has a local convex/concave shape and the like, the radius of the solder ball area 312 can be hypothetically defined on the assumption that the solder ball 210 has a perfect circular shape.

Also, in the board inspection system 100 according to this embodiment, as described above, the inspection apparatus controller 21 determines that the shape of the solder ball 210 is proper if the index value V is not greater than a predetermined threshold, and determines that the shape of the solder ball 210 is improper if the index value V is greater than the predetermined threshold. Accordingly, it is possible to easily determine whether the shape of the solder ball 210 is proper or improper based on a simple comparison of whether the index value V is not greater than the predetermined threshold or the index value V is greater than the predetermined threshold.

Also, in the board inspection system 100 according to this embodiment, as described above, the inspection apparatus controller 21 calculates a result indicating whether the solder ball 210 has a convex part or a concave part based on differences between an average radius Rₐᵥₑ of the solder ball area 312 in the determination image 310 and the plurality of distances di from the center of gravity G to the plurality of outer edge parts Ei of the solder ball area 312. This allows the convex and concave parts of the 210 solder balls to be distinguished, so that, for example, only the board 200 on which the 210 solder balls with convex parts are placed can be treated as defective.

Also, in the board inspection system 100 according to this embodiment, as described above, the inspection apparatus controller 21 outputs a result indicating that the solder ball 210 has the concave part if the number of the outer edge parts Ei that satisfy a negative-value condition in which the difference between the average radius Rₐᵥₑ of the solder ball area 312 in the determination image 310 and the distance di from the center of gravity G to each outer edge part of the solder ball area 312 is a negative value is greater than the number of the outer edge parts that satisfy a positive-value condition in which the difference between the average radius of the solder ball area in the determination image and the distance from the center of gravity to each outer edge part of the solder ball area is a positive value, and outputs a result indicating that the solder ball 210 has the convex part if the number of the outer edge parts that satisfy the positive-value condition is greater than the number of the outer edge parts that satisfy the negative-value condition. Accordingly, it is possible to easily obtain a result indicating whether the solder ball 210 has a concave part or a convex part based on whether the difference between the average radius Rₐᵥₑ of the solder ball area 312 in the determination image 310 and the distance di from the center of gravity G to each outer edge part of the solder ball area 312 Ei is a negative value or a positive value.

Also, in the board inspection system 100 according to this embodiment, as described above, the inspection apparatus controller 21 causes the solder ball 210 captured in the determination image 310 to be identifiably displayed on the display 23, together with an indication of whether the solder ball area has a proper shape or an improper shape. Accordingly, an operator or similar personnel can easily visually identify which of the solder balls 210 placed on the board 200 has an improper shape.

### Advantages of Board Inspection Method

As described above, the board inspection method according to this embodiment includes an imaging step of performing X-ray imaging of the board 200 on which the solder balls 210 are placed; step S1 as an X-ray image generation step of generating the X-ray image 300 of the board 200 captured by the X-ray imaging; step S2 as a determination-image generation step of generating the determination image 310 based on the X-ray image 300; and step S4 as a determination step of determining whether a shape of each solder ball 210 is proper or improper based on a plurality of distances di from a center of gravity G of the solder ball area 312 to a plurality of outer edge parts Ei of the solder ball area in the determination image 310. Accordingly, even in a case in which the solder ball 210 has a local convex/concave shape or the like, which cannot be evaluated by its roundness, it is possible to determine whether a shape of the solder ball 210 is proper or improper by using a difference between distances di from a local convex/concave part having the local convex/concave shape or the like and a round part to the center of gravity G. Consequently, it is possible to provide the board inspection method capable of accurately determining whether the shape of the solder ball 210 is proper or improper.

### MODIFIED EMBODIMENTS

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

For example, while the example in which the inspection apparatus controller 21 calculates an index value V for determining whether the shape of the solder ball 210 is proper or improper based on distances di from the center of gravity G to the outer edge parts Ei of the solder ball area 312 in the determination image 310 has been shown in the aforementioned embodiment, the present invention is not limited to this. In the present invention, the distances di from the center of gravity G to the outer edge parts Ei of the solder ball area 312 in the determination image 310 may be directly used for determination without newly calculating the index value V. In this case, for example, it may be determined that the solder ball 210 has an improper shape if the distance di of its solder ball area 312 include a value not smaller than a predetermined distance threshold.

Also, while the example in which the inspection apparatus controller 21 calculates the index value V based on differences between an average radius Rₐᵥₑ calculated based on an area S of the solder ball area 312 in the determination image 310 and the plurality of distances di from the center of gravity G to the plurality of outer edge parts Ei of the solder ball area 312 has been shown in the aforementioned embodiment, the present invention is not limited to this. In the present invention, the index value V may be calculated by using an average radius Rₐᵥₑ that is calculated based on a volume and weight of the solder ball 210, or a predetermined average radius Rₐᵥₑ, for example.

Also, while the example in which the inspection apparatus controller 21 calculates a mean squared error between the average radius Rₐᵥₑ calculated based on the area S of the solder ball area 312 in the determination image 310 and the plurality of distances di from the center of gravity G to the plurality of outer edge parts Ei of the solder ball area 312 as the index value V has been shown in the aforementioned embodiment, the present invention is not limited to this. In the present invention, the differences between the average radius Rₐᵥₑ calculated based on the area S of the solder ball area 312 in the determination image 310 and the plurality of distances di from the center of gravity G to the plurality of outer edge parts Ei of the solder ball area 312 may be directly set as the index value V.

Also, while the example in which the inspection apparatus controller 21 calculates the area S of each solder ball area 312 based on the number of pixels that are included in the solder ball area 312 in the determination image 310 and the area of each pixel, calculates the average radius Rₐᵥₑ of the solder ball area 312 based on the area S calculated of 312 the solder ball area and pi, and calculates the index value V based on the differences between the calculated average radius Rₐᵥₑ of the solder ball area 312 and the plurality of distances di from the center of gravity G to the plurality of outer edge parts Ei of the solder ball area 312 has been shown in the aforementioned embodiment, the present invention is not limited to this. In the present invention, the index value V may be calculated by calculating the average radius Rₐᵥₑ by using, for example, the area S of the solder ball area 312 calculated based on a volume and weight of the solder ball 210, a predetermined area or the like.

Also, while the example in which the inspection apparatus controller 21 determines that the shape of the solder ball 210 is proper if the index value V is not greater than a predetermined threshold 3.0, and determines that the shape of the solder ball 210 is improper if the index value V is greater than the predetermined threshold 3.0 has been shown in the aforementioned embodiment, the present invention is not limited to this. In the present invention, the predetermined threshold may be changed to any value by the operator or similar personnel. Also, the shape of the solder ball 210 may be determined to be proper if the index value V is smaller than a predetermined threshold, and the shape of the solder ball 210 may be determined to an improper if the index value is not smaller than the predetermined threshold.

Also, while the example in which the inspection apparatus controller 21 calculates a result indicating whether the solder ball 210 has a convex part or a concave part based on differences between an average radius Rₐᵥₑ of the solder ball area 312 in the determination image 310 and the plurality of distances di from the center of gravity G to the plurality of outer edge parts Ei of the solder ball area 312 has been shown in the aforementioned embodiment, the present invention is not limited to this. In the present invention, determination whether a shape of the solder ball 210 is proper or improper may be completed without calculating the result indicating whether the solder ball 210 has a convex part or a concave part. In this case, step S5 is omitted in the flowchart of FIG. 9.

Also, while the example in which the inspection apparatus controller 21 determines that a shape of the solder ball area 312 is improper if the solder ball area includes a convex part or a concave part has been shown in the aforementioned embodiment, the present invention is not limited to this. In the present invention, the inspection apparatus controller 21 can determine that the shape of the solder ball area 312 is improper if the solder ball area 312 includes both convex and concave parts, as shown in FIG. 10. In this case, since differences between the distances di and the average radius Rₐᵥₑ become large both in the convex and concave parts so that an absolute value of (Rₐᵥₑ−dᵢ)² used to calculate the index value V become large, the index value V relating to the solder ball area 312 shown in FIG. 10 will be larger as compared with the index value V of the solder ball area 312 that has a proper shape.

Also, while the example in which the inspection apparatus controller 21 outputs a result indicating that the solder ball 210 has the concave part if the number of the outer edge parts Ei that satisfy a negative-value condition in which the difference between the average radius Rₐᵥₑ of the solder ball area 312 in the determination image 310 and the distance di from the center of gravity G to each outer edge part of the solder ball area 312 is a negative value is greater than the number of the outer edge parts that satisfy a positive-value condition in which the difference between the average radius of the solder ball area in the determination image and the distance from the center of gravity to each outer edge part of the solder ball area is a positive value, and outputs a result indicating that the solder ball 210 has the convex part if the number of the outer edge parts that satisfy the positive-value condition is greater than the number of the outer edge parts that satisfy the negative-value condition has been shown in the aforementioned embodiment, the present invention is not limited to this. In the present invention, the inspection apparatus controller may calculate a result indicating whether the solder ball 210 has a convex part or a concave part based on the maximum or minimum value in the differences between the average radius Rₐᵥₑ of the solder ball area 312 in the determination image 310 and the plurality of distances di from the center of gravity G to the plurality of outer edge parts Ei of the solder ball area 312, for example.

Also, while the example in which the inspection apparatus controller 21 causes the solder ball 210 captured in the determination image 310 to be identifiably displayed on the display 23, together with an indication of whether the solder ball area has a proper shape or an improper shape has been shown in the aforementioned embodiment, the present invention is not limited to this. In the present invention, the solder ball 210 captured in the determination image 310 may be identifiably displayed on a display provided separately from the board inspection apparatus 20, together with an indication of whether the solder ball has a proper shape or an improper shape, for example.

While the example in which the board inspection system 100 includes the solder ball inference apparatus 30 has been shown in the aforementioned embodiment, the present invention is not limited to this. In the present invention, the board inspection system 100 may not include the solder ball inference apparatus 30. In this case, the solder ball inference apparatus 30 may be provided separately from the board inspection system 100.

Also, while the example in which the board inspection system 100 inspects shapes of the plurality of solder balls 210 having sizes similar to each other has been shown in the aforementioned embodiment, the present invention is not limited to this. In the present invention, the board inspection system 100 may inspect shapes of a plurality of solder balls 210 having different sizes from each other.

Also, while the example in which the board inspection system 100 inspects shapes of the plurality of solder balls 210 placed on the board 200 all at once has been shown in the aforementioned embodiment, the present invention is not limited to this. In the present invention, the board inspection system 100 may inspect shapes of the solder balls 210 placed on the board 200 one after another.

Also, while the example in which the inspection apparatus controller 21 highlights the solder ball area that has an improper shape with a thick line on the display 23 has been shown in the aforementioned embodiment, the present invention is not limited to this. In the present invention, the solder ball areas 312 may be displayed in any style as long as they are identifiably displayed, together with an indication of whether they have a proper shape or an improper shape, for example, the index values V of the solder ball areas 312 may be superimposed on the solder ball areas 312 in addition to their figures, or the index values may be indicated in a table separately from the image. Also, an audible tone may be produced if the board 200 with the solder ball 210 that has an improper shape is found.

Also, while the example in which the inference apparatus controller 31 of the solder ball inference apparatus 30 generates the inference image representing the probability of the part that is the solder ball area 312 in the X-ray image 300, which is input from the inspection apparatus controller 21 of the board inspection apparatus 20, by using the learned model 32a stored in the inference apparatus storage 32 of the solder ball inference apparatus 30 has been shown in the aforementioned embodiment, the present invention is not limited to this. In the present invention, the inspection apparatus controller 21 of the board inspection apparatus 20 may generate an inference image representing a probability of a part of the X-ray image 300 that is the solder ball area 312 by using a learned model stored in the inspection apparatus storage 22 of the board inspection apparatus 20.

### MODES

It is understood by those skilled in the art that the exemplary embodiments described above are specific examples of the following aspects.

### Mode Item 1

A board inspection system includes an X-ray imaging apparatus performing X-ray imaging of a board on which a solder ball is placed; and an inspection apparatus including a controller generating an X-ray image of the board captured by the X-ray imaging through the X-ray imaging apparatus, wherein the controller generates a determination image based on the X-ray image of the board captured by the X-ray imaging through the X-ray imaging apparatus, and determines whether a shape of the solder ball is proper or improper based on a plurality of distances from a center of gravity of a solder ball area to a plurality of outer edge parts of the solder ball area in the determination image.

### Mode Item 2

In the board inspection system according to mode item 1, the controller calculates an index value for determining whether the shape of the solder ball is proper or improper based on the plurality of distances from the center of gravity to the plurality of outer edge parts of the solder ball area in the determination image.

### Mode Item 3

In the board inspection system according to mode item 2, the controller calculates the index value based on differences between an average radius calculated based on an area of the solder ball area in the determination image and the plurality of distances from the center of gravity to the plurality of outer edge parts of the solder ball area.

### Mode Item 4

In the board inspection system according to mode item 3, the controller calculates a mean squared error between the average radius calculated based on the area of the solder ball area in the determination image and the plurality of distances from the center of gravity to the plurality of outer edge parts of the solder ball area as the index value.

### Mode Item 5

In the board inspection system according to mode item 3, the controller calculates the area of the solder ball area based on a number of pixels that are included in the solder ball area in the determination image and an area of each pixel, calculates the average radius of the solder ball area based on the calculated area of the solder ball area and pi, and calculates the index value based on the differences between the calculated average radius of the solder ball area and the plurality of distances from the center of gravity to the plurality of outer edge parts of the solder ball area.

### Mode Item 6

In the board inspection system according to mode item 2, the controller determines that the shape of the solder ball is proper if the index value is not greater than a predetermined threshold, and determines that the shape of the solder ball is improper if the index value is greater than the predetermined threshold.

### Mode Item 7

In the board inspection system according to mode item 1, the controller calculates a result indicating whether the solder ball has a convex part or a concave part based on differences between an average radius of the solder ball area in the determination image and the plurality of distances from the center of gravity to the plurality of outer edge parts of the solder ball area.

### Mode Item 8

In the board inspection system according to mode item 7, the controller outputs a result indicating that the solder ball has the concave part if a number of outer edge parts that satisfy a negative-value condition in which the difference between the average radius of the solder ball area in the determination image and the distance from the center of gravity to each outer edge part of the solder ball area is a negative value is greater than a number of outer edge parts that satisfy a positive-value condition in which the difference between the average radius of the solder ball area in the determination image and the distance from the center of gravity to each outer edge part of the solder ball area is a positive value, and outputs a result indicating that the solder ball has the convex part if the number of the outer edge parts that satisfy the positive-value condition is greater than the number of the outer edge parts that satisfy the negative-value condition.

### Mode Item 9

In the board inspection system according to mode item 1, the inspection apparatus further includes a display; and the controller causes the solder ball area captured in the determination image to be identifiably displayed on the display, together with an indication of whether the solder ball area has a proper shape or an improper shape.

### Mode Item 10

A board inspection method includes an imaging step performing X-ray imaging of a board on which a solder ball is placed; an X-ray image generation step of generating an X-ray image of the board captured by the X-ray imaging; a determination-image generation step of generating a determination image based on the X-ray image; and a determination step of determining whether a shape of the solder ball is proper or improper based on a plurality of distances from a center of gravity of a solder ball area to a plurality of outer edge parts of the solder ball area in the determination image.

What is claimed is:

1. A board inspection system comprising:
an X-ray imaging apparatus performing X-ray imaging of a board on which a solder ball is placed; and
an inspection apparatus including a controller generating an X-ray image of the board captured by the X-ray imaging through the X-ray imaging apparatus, wherein
the controller generates a determination image based on the X-ray image of the board captured by the X-ray imaging through the X-ray imaging apparatus, and determines whether a shape of the solder ball is proper or improper based on a plurality of distances from a center of gravity of a solder ball area to a plurality of outer edge parts of the solder ball area in the determination image.

2. The board inspection system according to claim 1, wherein the controller calculates an index value for determining whether the shape of the solder ball is proper or improper based on the plurality of distances from the center of gravity to the plurality of outer edge parts of the solder ball area in the determination image.

3. The board inspection system according to claim 2, wherein the controller calculates the index value based on differences between an average radius calculated based on an area of the solder ball area in the determination image and the plurality of distances from the center of gravity to the plurality of outer edge parts of the solder ball area.

4. The board inspection system according to claim 3, wherein the controller calculates a mean squared error between the average radius calculated based on the area of the solder ball area in the determination image and the plurality of distances from the center of gravity to the plurality of outer edge parts of the solder ball area as the index value.

5. The board inspection system according to claim 3, wherein the controller calculates the area of the solder ball area based on a number of pixels that are included in the solder ball area in the determination image and an area of each pixel, calculates the average radius of the solder ball area based on the calculated area of the solder ball area and pi, and calculates the index value based on the differences between the calculated average radius of the solder ball area and the plurality of distances from the center of gravity to the plurality of outer edge parts of the solder ball area.

6. The board inspection system according to claim 2, wherein the controller determines that the shape of the solder ball is proper if the index value is not greater than a predetermined threshold, and determines that the shape of the solder ball is improper if the index value is greater than the predetermined threshold.

7. The board inspection system according to claim 1, wherein the controller calculates a result indicating whether the solder ball has a convex part or a concave part based on differences between an average radius of the solder ball area in the determination image and the plurality of distances from the center of gravity to the plurality of outer edge parts of the solder ball area.

8. The board inspection system according to claim 7, wherein the controller outputs a result indicating that the solder ball has the concave part if a number of outer edge parts that satisfy a negative-value condition in which the difference between the average radius of the solder ball area in the determination image and the distance from the center of gravity to each outer edge part of the solder ball area is a negative value is greater than a number of outer edge parts that satisfy a positive-value condition in which the difference between the average radius of the solder ball area in the determination image and the distance from the center of gravity to each outer edge part of the solder ball area is a positive value, and outputs a result indicating that the solder ball has the convex part if the number of the outer edge parts that satisfy the positive-value condition is greater than the number of the outer edge parts that satisfy the negative-value condition.

9. The board inspection system according to claim 1, wherein
the inspection apparatus further includes a display; and
the controller causes the solder ball area captured in the determination image to be identifiably displayed on the display, together with an indication of whether the solder ball area has a proper shape or an improper shape.

10. A board inspection method comprising:
an imaging step performing X-ray imaging of a board on which a solder ball is placed;
an X-ray image generation step of generating an X-ray image of the board captured by the X-ray imaging;
a determination-image generation step of generating a determination image based on the X-ray image; and
a determination step of determining whether a shape of the solder ball is proper or improper based on a plurality of distances from a center of gravity of a solder ball area to a plurality of outer edge parts of the solder ball area in the determination image.

11. The board inspection method according to claim 10, further comprising an index-value calculation step calculating an index value for determining whether the shape of the solder ball is proper or improper based on the plurality of distances from the center of gravity to the plurality of outer edge parts of the solder ball area in the determination image prior to the determination step.

12. The board inspection method according to claim 11, wherein the index value is calculated based on differences between an average radius calculated based on an area of the solder ball area in the determination image and the plurality of distances from the center of gravity to the plurality of outer edge parts of the solder ball area.

13. The board inspection method according to claim 12, wherein a mean squared error between the average radius calculated based on the area of the solder ball area in the determination image and the plurality of distances from the center of gravity to the plurality of outer edge parts of the solder ball area is calculated as the index value in the index-value calculation step.

14. The board inspection method according to claim 12, wherein the area of the solder ball area is calculated based on a number of pixels that are included in the solder ball area in the determination image and an area of each pixel, the average radius of the solder ball area is calculated based on the calculated area of the solder ball area and pi, and the index value is calculated based on the differences between the calculated average radius of the solder ball area and the plurality of distances from the center of gravity to the plurality of outer edge parts of the solder ball area in the index-value calculation step.

15. The board inspection method according to claim 11, wherein the shape of the solder ball is determined to be proper if the index value is not greater than a predetermined threshold, and the shape of the solder ball is determined to be improper if the index value is greater than the predetermined threshold in the determination step.

16. The board inspection method according to claim 10 further comprising a convexity/concavity result calculation step calculating a result indicating whether the solder ball has a convex part or a concave part based on differences between an average radius of the solder ball area in the determination image and the plurality of distances from the center of gravity to the plurality of outer edge parts of the solder ball area.

17. The board inspection method according to claim 16, wherein a result indicating that the solder ball has the concave part is output if a number of outer edge parts that satisfy a negative-value condition in which the difference between the average radius of the solder ball area in the determination image and the distance from the center of gravity to each outer edge part of the solder ball area is a negative value is greater than a number of outer edge parts that satisfy a positive-value condition in which the difference between the average radius of the solder ball area in the determination image and the distance from the center of gravity to each outer edge part of the solder ball area is a positive value, and a result indicating that the solder ball has the convex part is output if the number of outer edge parts that satisfy a positive-value condition is greater than the number of the outer edge parts that satisfy the negative-value condition in the convexity/concavity result calculation step.

18. The board inspection method according to claim 10 further comprising a display step causing the solder ball area captured in the determination image to be identifiably displayed on a display, together with an indication of whether the solder ball area has a proper shape or an improper shape.
